(19) United States
(12) Patent Application Publication
(10) Pub. No.: US 2008/0105551 A1
(43) Pub. Date: May 8, 2008

(54) Supercapacitor desalination devices and methods of making the same

(76) Inventors: Shengxian Wang, Shanghai (CN); Chang Wei, Niskayuna, NY (US); Lei Cao, Shanghai (CN); Rihua Xiong, Shanghai (CN); Wei Cai, Shanghai (CN); Yu Du, Shanghai (CN)

Correspondence Address: GENERAL ELECTRIC COMPANY (PCPI);C/O FLETCHER YODER, P. O. BOX 692289, HOUSTON, TX, 77269-2289, US

(21) Appl. No.: 11/300,535

(22) Filed: Dec. 14, 2005

(51) Int. Cl. B01D 61/42

(52) U.S. Cl. 204/627

(57) ABSTRACT

A supercapacitor desalination cell is provided. The cell includes electrodes formed of conducting materials that are configured to adsorb ions in a charging state of the cell and desorb the ions in a discharging state of the cell. The conducting materials comprise conducting composites. An insulating spacer is disposed between the two electrodes and is configured to electrically isolate one electrode from the other. Further, the cell includes a first current collector coupled to the first electrode, and a second current collector coupled to the second electrode. Further, an energy recovery converter may be operatively associated with the cell and configured to recover energy released by the cell while transforming from a charging state to a discharging state. The converter is configured to transfer at least a portion of the recovered energy to a grid in the discharging state of the cell.

### BACKGROUND

The invention relates generally to the field of supercapacitor desalination of liquids having charged species, and more particularly to supercapacitor desalination devices having energy recovery converters and methods of making the same.

Less than one percent of water on the earth's surface is suitable for direct consumption in domestic or industrial applications. With the limited sources of natural drinking water, de-ionization of seawater, commonly known as desalination, is the most economical way to produce fresh water. However, as compared to other brackish waters, seawater has a relatively higher content of “total dissolved solids” (TDS). As will be appreciated, the total amount of charged species in a liquid is expressed as TDS. Typically, TDS is expressed in terms of parts per million (ppm). In organic or inorganic liquid wastes, in addition to the charged species originally present, TDS may be increased by species generated as a result of hydrolysis, decomposition, flocculation, biological or chemical reaction of solutes.

In waste water treatment, or desalination, reduction of TDS is one of the major goals. For domestic and/or industrial applications, it is desirable to reduce the TDS levels to certain values. De-ionization of liquids, such as industrial waste or seawater, may result in lower TDS levels. De-ionization may be achieved by employing techniques, such as ion-exchange, distillation, reverse osmosis (RO), and electro-dialysis.

However, in choosing among these processes, one has to consider the cost of the process, which also includes the cost involved in energy consumption. Disadvantageously, these processes consume vast amounts of energy. In order to make the produced water affordable to a majority of the consumers, it is desirable to reduce the total energy consumption involved in the process, thereby making the process relatively less costly. Also, it is desirable to maximize the use of available energy by the system. For example, in the case of supercapacitor desalination, where the feed liquid is made to flow between pairs of parallel conducting plates, which are maintained at reverse polarization to create electrostatic charges, it is desirable to maximize the charge separation at the conductive plates during the flow of water, to avoid repeating the process to bring down the TDS levels in the liquid.

### BRIEF DESCRIPTION

In accordance with one aspect of the invention, a supercapacitor desalination cell is provided. The cell includes a first electrode having a first conducting material, where the first electrode is configured to adsorb ions in a charging state of the cell and desorb the ions in a discharging state of the cell, and where the first conducting material comprises a conducting composite. Further, the cell includes a second electrode having a second conducting material, where the second electrode is configured to adsorb ions in a charging state of the cell and desorb the ions in a discharging state of the cell, and where the second conducting material comprises a conducting composite. Further, the cell includes an insulating spacer disposed between the first and second electrodes, where the insulating spacer is configured to electrically isolate the first electrode from the second electrode. Further, the cell also includes a first current collector coupled to the first electrode, and a second current collector coupled to the second electrode.

In accordance with another aspect of the invention, a supercapacitor desalination device configured to alternate between a charging state and a discharging state is provided. The device includes a supercapacitor desalination cell configured to adsorb charged species in a charging state, and desorb the charged species in a discharging state. Further, energy is stored by the cell in the charging state and released by the cell in the discharging state. The device further includes an energy recovery converter operatively associated with the cell and configured to recover the stored energy from the cell in the discharging state of the cell, where the converter is configured to transfer at least a portion of the recovered energy to a grid.

In accordance with yet another aspect of the invention, a system configured to de-ionize a liquid having charged species is provided. The system includes a plurality of stacks, where each of the plurality of stacks includes a plurality of cells of the present technique. Further, the system includes a plurality of converters, such that each of the plurality of converters is coupled to a respective stack, and where each of the plurality of converters is configured to store at least a portion of energy released by the respective stack in the discharging state, and where each of the plurality of converters is configured to return at least a portion of the stored energy to the respective stack in the charging state.

### DRAWINGS

These and other features, aspects, and advantages of the invention will become better understood when the following detailed description is read with reference to the accompanying drawings in which like characters represent like parts throughout the drawings, wherein:

FIG. 1 is a schematic view of an exemplary supercapacitor desalination vessel employing a stack having a plurality of de-ionization cells according to certain embodiments of the invention;

FIG. 2 is an exploded perspective view of a portion of the stack of FIG. 1 illustrating an arrangement of electrodes, insulating spacers and current collectors;

FIG. 3 is a perspective view of an exemplary supercapacitor desalination cell during charging according to certain embodiments of the invention;

FIG. 4 is a diagrammatical representation of an energy flow in an exemplary supercapacitor desalination cell during charging and discharging of the cell according to certain embodiments of the invention;

FIG. 5 is a perspective view of an exemplary embodiment of a cylindrical supercapacitor desalination cell according to certain embodiments of the invention;

FIG. 6 is a diagrammatical representation of a system for de-ionization of liquids having charged species, the system employing a plurality of stacks and a plurality of energy recovery converters;

FIGS. 7-8 are block diagrams of exemplary systems for de-ionization of a liquid having charged species, the systems include a combination of supercapacitor desalination devices and reverse osmosis units;

FIG. 9 is an exemplary topology of a bi-directional half-bridge DC-DC converter according to certain embodiments of the invention;

FIG. 10 is an exemplary topology of an interleaved bi-directional half-bridge DC-DC converter according to certain embodiments of the invention; and

FIG. 11 is an exemplary topology of a bi-directional full-bridge DC-DC converter according to certain embodiments of the invention.

### DETAILED DESCRIPTION

A supercapacitor desalination (SCD) cell is typically employed for desalination of seawater or de-ionization of other brackish waters to reduce the amount of salt to a permissible level for domestic and industrial use. Such a cell may also be used to remove or reduce any other ionic impurities from a liquid.

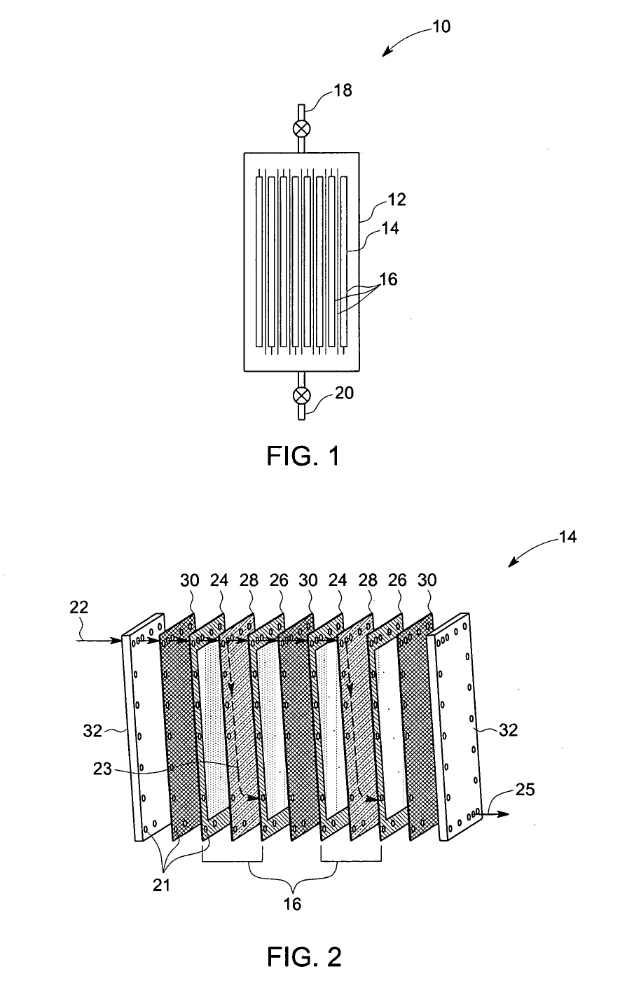

In certain embodiments, a supercapacitor desalination cell may include a first electrode, a second electrode, and an insulating spacer disposed therebetween. For the purpose of purification of a liquid by de-ionization, several of such cells may be disposed in a container which has provisions for water inlet and outlet. FIG. 1 illustrates a schematic view of an exemplary supercapacitor desalination device 10 employing a desalination vessel 12. The vessel 12 houses a supercapacitor desalination stack 14 having a plurality of supercapacitor desalination cells 16. As will be described below with regard to FIG. 2, each of the plurality of cells 16 includes a pair of electrodes, an insulating spacer and a pair of current collectors. Further, the vessel 12 includes an inlet 18 from where the feed liquid, that is, the liquid that is to be de-ionized, enters the vessel 12. Further, the vessel 12 includes an outlet 20 from where the liquid exits the vessel 12 after being at least partially de-ionized by the supercapacitor desalination cells 16. As will be appreciated, the liquid may be guided inside the vessel 12 by using external forces such as, pumping.

In certain embodiments, the feed liquid may be passed through the stack 14 more than one time, that is, more than one iteration may be required to de-ionize the liquid to permissible or desirable levels of charged species. In certain embodiments, a plurality of such cells 16 may be arranged in a vessel, such as the vessel 12, such that the output of one cell may be treated as a feed liquid for the other cell. This way, the liquid may be allowed to pass through the de-ionization cells 16 several times before coming out of the outlet 20.

In an exemplary embodiment, a sample sea-water having TDS values of 35000 ppm is subjected to five or more iterations of de-ionization to achieve the TDS values of about 500 ppm, with an 80 percent water recovery. In another example, a sample of sea water having about 3.5 weight percent of charged species concentration is subjected to several iterations of de-ionization to lower the concentration to about 0.03 weight percent. Exemplary systems fabricated in accordance with this embodiment yielded test results wherein the first iteration yielded water having 3 weight percent concentration, the second iteration yielded water having 2 weight percent, and the final iteration yielded water having 0.03 weight percent of charged species concentration.

In certain embodiments, the vessel 12 may be made of materials, such as stainless steel, acrylics, polycarbonates, polyvinyl chloride (PVC), polyethylene, or combinations thereof. As will be appreciated, the selection of materials for the vessel 12 is such that the material of the vessel 12 should not contribute to the impurities of the liquid which is to be de-ionized. The vessel 12 may be cylindrical in shape. Further, the vessel 12 may be shaped such that it converges at the inlets and outlets, as illustrated in FIG. 1.

FIG. 2 illustrates an arrangement of the various elements employed in a supercapacitor desalination stack, such as the stack 14 of FIG. 1. In the illustrated embodiment, the supercapacitor desalination stack 14 includes a plurality of supercapacitor desalination cells 16, which act as capacitors. The supercapacitor desalination cells 16 include a pair of electrodes, wherein each pair includes first electrodes 24, second electrodes 26, and insulating spacers 28 disposed therebetween. The stack 14 also includes a number of current collectors 30 disposed between each de-ionization cell 16, as will be described further below. In certain embodiments, in the charging state of the stack 14, the first and second electrodes 24 and 26 are configured to adsorb ions from the liquid that is to be de-ionized. In these embodiments, in the charging state, the surfaces of the first and second electrodes 24 and 26 accumulate electric charges. Subsequently, when the liquid is flowed through these electrodes, the electric charges accumulated on the electrodes 24 and 26 attract oppositely charged ions from the liquid, and these charged ions are then adsorbed on the surface of the electrodes 24 and 26. As the electrodes 24 and/or 26 are saturated with the adsorbed charged ions, the charged ions may be removed or desorbed from the surface of the electrodes 24 and/or 26 by discharging the cell 16. In the discharging state, the adsorbed ions dissociate from the surface of the first and second electrodes 24 and 26 and may combine with the liquid flowing through the cell 16 during the discharging state, as will be described in detail below. In some embodiments, during the discharging state of the cell 16, the polarities of the electrodes 24 and 26 may be reversed. While in other embodiments, during the discharging state of the cell 16, the polarities of the electrodes 24 and 26 may be maintained the same.

In certain embodiments, each of the first electrodes 24 may include a first conducting material and each of the second electrodes 26 may include a second conducting material. As used herein the term conducting material refers to materials that are electrically conducting. These materials may or may not be thermally conducting. In these embodiments, the first and second conducting materials may include a conducting composite, for example, a conducting polymer. In some embodiments, the first and second conducting materials may have particles with smaller sizes and large surface areas. As will be appreciated, due to large surface areas such conducting materials may result in high adsorption capacity, high energy density and high capacitance of the cell 16. In some embodiments, the first and second conducting materials may include particles having a size of less than about 100 microns. In exemplary embodiments, the particle size of the first and second conducting materials may be in a range from about 5 microns to about 10 microns, from about 10 microns to about 30 microns, from about 30 microns to about 60 microns, or from about 60 microns to less than about 100 microns. In these embodiments, the capacitance of the stack 14 may be about 100 Farad per gram. Further, in these embodiments, the first and second conducting materials deposited on the surfaces of the first and second electrodes 24 and 26 may have high porosity. In one embodiment, the porosity of the first and/or second materials may be in a range from about 10 percent to about 95 percent.

Further, the first and second conducting materials may include organic or inorganic materials, for example, these conducting materials may include polymers, or may include inorganic composites which are conductive. In another exemplary embodiment, the inorganic conducting material may include carbon, metal or metal oxide. Further, the first and second electrodes 24 and 26 may employ the same materials. That is, the first and second conducting materials may be same. Alternatively, the first and second conductive electrodes may employ different materials. Additionally, in some embodiments, the first and second conducting materials may be reversibly doped. In these embodiments, the first and second materials may or may not be same. In an exemplary embodiment, the dopants may include either anions or cations. Non-limiting examples of cations may include Li⁺, Na⁺, K⁺, NH₄⁺, Mg²⁺, Ca²⁺, Zn²⁺, Fe²⁺, Al³⁺, or combinations thereof. Non-limiting examples of anions may include Cl⁻, NO₃⁻, SO₄²⁻, PO₄⁻³, or combinations thereof.

In certain embodiments, the conducting polymers may include polypyrrole, polythiophene, polyaniline. In some embodiments, the conducting polymers may include sulfonic, chloride, fluoride, alkyl, or phenyl derivates of polypyrrole, polythiophene, or polyaniline. In one embodiment, the conducting material may include carbon, or carbon based materials. In an exemplary embodiment, the carbon based materials may include activated carbon particles, porous carbon particles, carbon fibers, carbon nanotubes, carbon aerogel, or combinations thereof. In some embodiments, the first and second conducting composites may include carbides of titanium, zirconium, vanadium, tantalum, tungsten, niobium, or combinations thereof. In some embodiments, the first and second conducting composites may include oxides of manganese, or iron, or both. In an exemplary embodiment, the conducting material may include nanopowders, such as ferrites.

Additionally, electrically conducting fillers may also be used along with the conducting materials. Also, suitable adhesives, hardeners, or catalysts may also be employed with the conducting materials. Filler materials or additives may affect one or more attributes of the conducting materials, such as minimum width, viscosity, cure profile, adhesion, electrical properties, chemical resistance (e.g., moisture resistance, solvent resistance), glass transition, thermal conductivity, heat distortion temperature, and the like.

In some embodiments, the filler may have an average particle diameter of less than about 500 micrometers. In exemplary embodiments, the filler may have an average particle diameter in a range of from about 1 nanometer to about 5 nanometers, from about 5 nanometers to about 10 nanometers, from about 10 nanometers to about 50 nanometers, or greater than about 50 nanometers.

In certain embodiments, filler particles may have varying shapes and sizes that may be selected based on application specific criteria. Suitable shapes may include one or more of spherical particles, semi-spherical particles, rods, fibers, geometric shapes, and the like. The particles may be hollow or solid-cored, or may be porous. Long particles, such as rods and fibers may have a length that differs from a width.

In embodiments where an electrically conducting polymer is employed as a conducting material, the capacitance of the cell 16 may be enhanced due to the reversible Faradic mechanism or the electron transfer mechanism of the polymer. In an exemplary embodiment, the capacitance of the cell 16 may be increased by about 3 to about 5 times. Such capacitance values are higher than the capacitance values of a cell, such as cell 16, employing active carbon materials. In some embodiments, the capacitance of the cell 16 employing conducting polymer composites may be in a range from about 100 Farad per gram to about 800 Farad per gram. Due to the high values of capacitance the first and second electrodes 24 and 26 may adsorb a considerable amount of ions on their respective surfaces without requiring high operational pressure or electrochemical reactions, thereby resulting in relatively less energy consumption as compared to reverse osmosis (RO) or electro-dialysis (ED). As will be appreciated, electrochemical reactions or electrolysis consumes more energy and may be detrimental to the life of the electrodes. Additionally, the high surface area of the conducting polymers facilitates the deposition of relatively higher amounts of ions, thereby facilitating reduction in the footprint of the device. As used herein, “footprint” refers to the number of supercapacitor desalination cells employed in a given stack, or a number of supercapacitor desalination stacks employed in a design in order to achieve a pre-determined productivity. In certain embodiments, the footprint of a supercapacitor desalination device having 200 stacks may be in a range from about 1 supercapacitor desalination cell to about 1000 supercapacitor desalination cells. That is, each of the stacks may employ a number of supercapacitor desalination cells varying between 1 and 1000.

Although in the illustrated embodiment, the electrodes 24 and 26 are in the form of plates which are disposed parallel to each other to form a stacked structure, in other embodiments, the first and second electrodes may have varied shapes. Also, these electrodes may be arranged in varying configurations. For example, in the illustrated embodiment of FIG. 5, the first and second electrodes may be disposed concentrically, as will be described in detail below.

In certain embodiments, the insulating spacer 28 may include electrically insulative polymers, such as polyethylene, poly vinyl chloride, polypropylene, Teflon, nylon, or combinations thereof. Further, the insulating spacer 28 may be in the form of a membrane and may have a thickness in a range from about 10⁻⁶ centimeters to about 1 centimeter.

Further, as illustrated, each of the cells 16 may include current collectors 30, which are coupled to the first and second electrodes 24 and 26. The current collectors are configured to conduct electrons and may affect the power consumption and lifetime of the cell 16. For example, a high contact resistance between the electrode 24 or 26 and the current collector 30 may result in high power consumption. In certain embodiments, the conducting material of the first and second electrodes 24 and 26 of the cell 16 may be deposited on the current collectors 30. In these embodiments, the conducting materials of the electrodes 24 and 26 may be deposited on the current collector by employing one or more deposition techniques, such as sputtering, spraying, spin-coating, printing, or coating.

In certain embodiments, the current collector 30 may include a foil, or a mesh. The current collector 30 may include an electrically conducting material, such as aluminum, copper, nickel, titanium, platinum, palladium, or combinations thereof. In one embodiment, the current collectors 30 may include titanium mesh. In another embodiment, the current collector 30 may include a carbon paper or a conductive carbon composite.

The stack 14 further includes support plates 32 to provide mechanical stability to the structure. The support plates 32 may also act as electrical contacts for the stack 14 to provide electrical communication between the stack 14 and the power supply, or the energy recovery converter. In the illustrated embodiment, the support plates 32, the electrodes 24 and 26, and the current collectors 30 may include holes 21 to direct the flow of liquid and to define a hydraulic flow path between the pair of electrodes. As illustrated, the liquid is directed inside the cell 16 from the direction indicated by the arrow 22. After entering the cell 16, the liquid is directed such that it flows through the surface of the electrodes 24 and 26 as indicated by the hydraulic flow path 23. It is desirable to flow the liquids such that the liquid traverses through the maximum portion of the surface of the electrodes 24 and 26. As will be appreciated, more contact time between the liquids and the surface of the electrodes may result in more adsorption of the charged species or ions from the liquid onto the surface of the electrodes. That is, more contact time between the liquids and the surface of the electrodes may result in a lesser number of iterations required to reduce the concentration of the charged species in the liquid to a predetermined value. Subsequently, the liquid exits the cell 16 as indicated by the arrow 25.

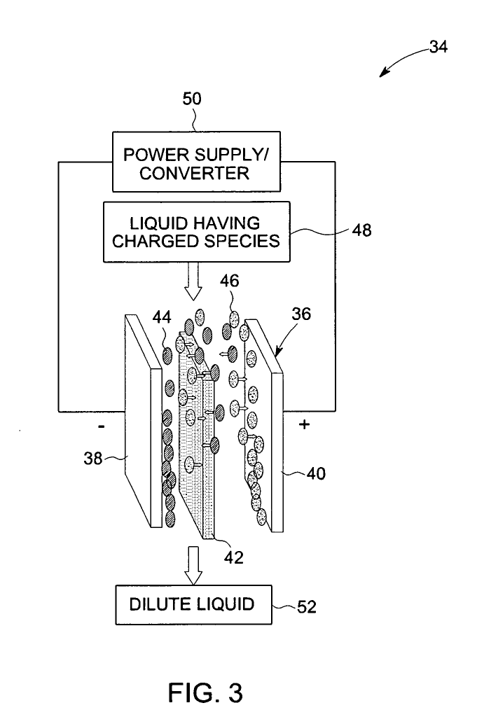

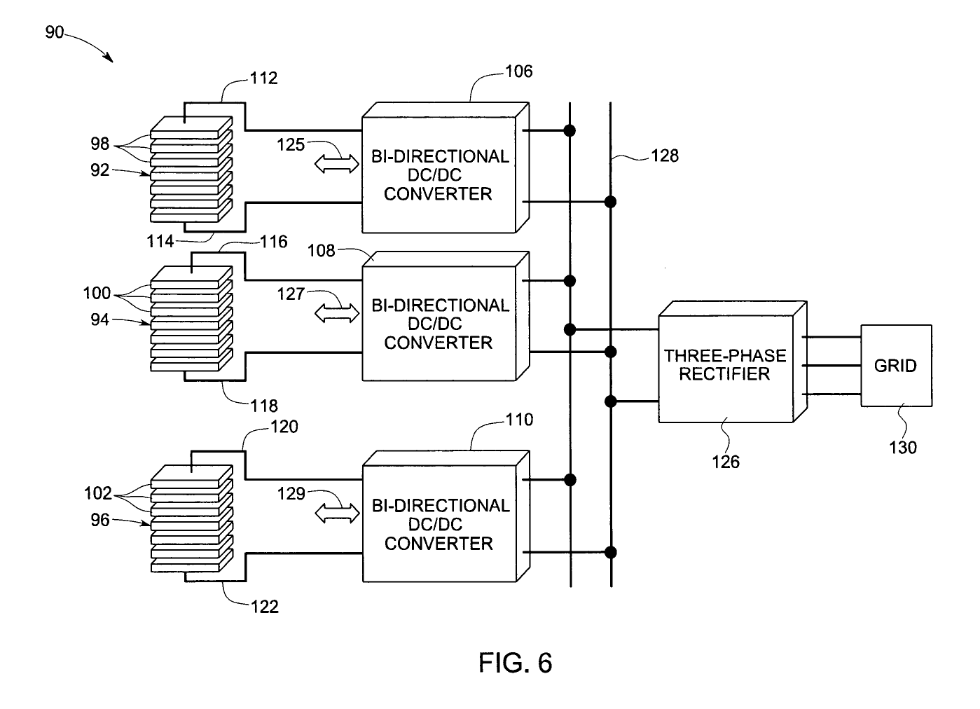

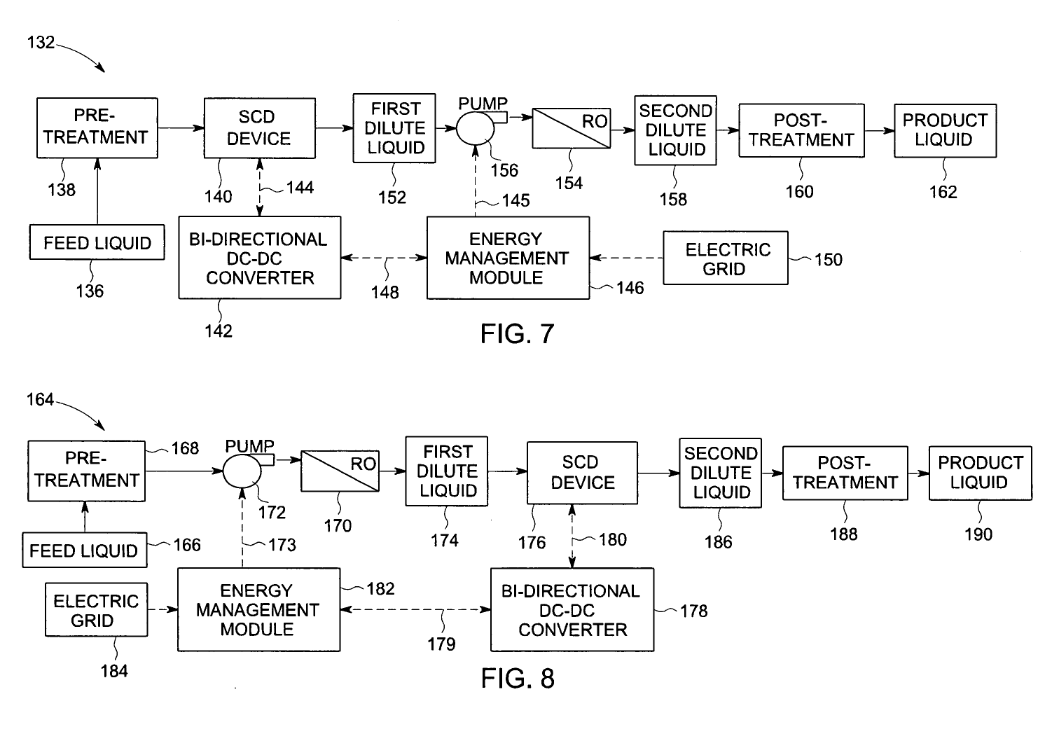

FIG. 3 illustrates a system 34 employing a supercapacitor desalination cell 36 during a charging state. As illustrated, the cell 36 is electrically coupled to a power supply 50. As will be described later with regard to FIG. 6, the power supply 50 may either act as an energy recovery converter or may be in operative association with the energy converter. In the illustrated embodiment, the electrode 38 is coupled to the negative terminal of the power supply 50 and acts as a cathode. Similarly, the electrode 40 is coupled to the positive terminal of the power supply 50 and acts as an anode. Further, an insulating spacer 42 is disposed between the two electrodes 38 and 40. When the liquid 48 having charged species is made to pass between the electrodes 38 and 40, the charged species or ions from the liquid accumulate at the oppositely charged electrodes. As illustrated, the cations 44 move towards the cathode 38 and the anions 46 move towards the anode 46. As a result of this charge accumulation inside the cell 36, the output liquid, or the dilute liquid 52 coming out of the cell 36 is lower in the concentration of charged species as compared to the feed liquid 48. As noted above, in certain embodiments, the dilute liquid 52 may be again subjected to de-ionization by feeding it through another cell similar to cell 36. In some embodiments, a plurality of such cells 36 may be employed in a stack, as previously described and as further described in detail with regard to FIG. 6. The system may also include several stacks. Alternatively, as described in detail with regard to FIGS. 7-8, the dilute liquid 52 may be fed into a device, which may perform a similar function as the cell 36. For example, a reverse osmosis unit may be coupled to the cell 36 to receive the liquid 52.

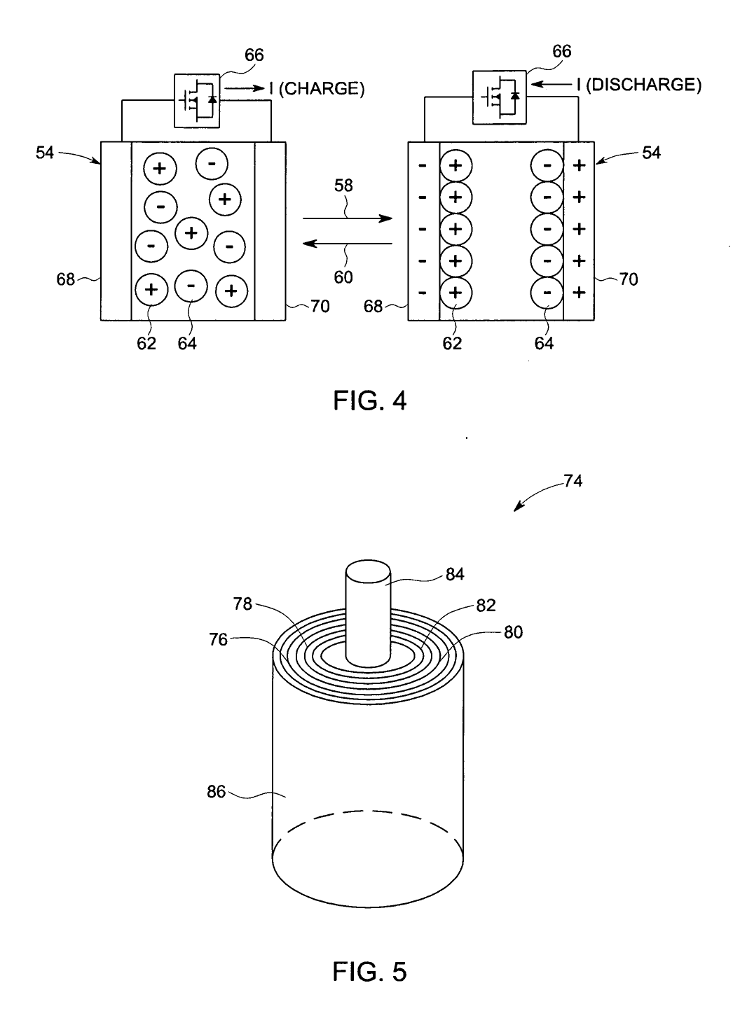

As noted above, during charging of a supercapacitor desalination cell, the charged species from the feed liquid are accumulated on the surface of the electrodes and keep building until the cell is discharged. FIG. 4 illustrates a charging state 58 and a discharging state 60 of a supercapacitor desalination cell 54. In the charging state 58, energy is stored by the cell 54, whereas in the discharging state 60, the stored energy is released by the cell 54. In the illustrated embodiment, the cell 54 includes electrodes 68 and 70. In the illustrated embodiment, in the charging state the electrode 68 is negatively charged to attract the positively charged ions 62 from the feed liquid. Similarly, the electrode 70 is positively charged to attract negatively charged ions 64 from the feed liquid. As will be appreciated, either of the electrodes 68 or 70 may be made positive or negative, and the polarity of the electrodes are determined by the manner of connection between the electrodes and the outer power supply. Either of the electrodes 68 or 70 may be made an anode by connecting to the positive pole of the power supply, and the other electrode then becomes the cathode. It should be noted that either arrangement makes no difference to the de-ionization performance of the cell 54.

Upon discharging, as indicated by the arrow 60, the charges from the electrode surfaces are desorbed by the electrodes into the feed liquid. In the illustrated embodiment, in the discharging state 60 of the cell 54, the cations 62 and anions 64 get desorbed from the electrodes 68 and 70 and move out of the cell 54 along with the feed liquid. Therefore, during the discharging state 60 the liquid coming out of the supercapacitor desalination cell 54 may be higher in ionic concentration as compared to the feed liquid, which is fed into the supercapacitor desalination cell 54. In other words, in the discharging state 60 of the cell 54, the TDS values of the product liquid may be more than those of the feed liquid. Accordingly, in the discharging state 60 the resulting liquid may not be mixed with the earlier dilute liquid, which may be obtained during the charging state of the cell.

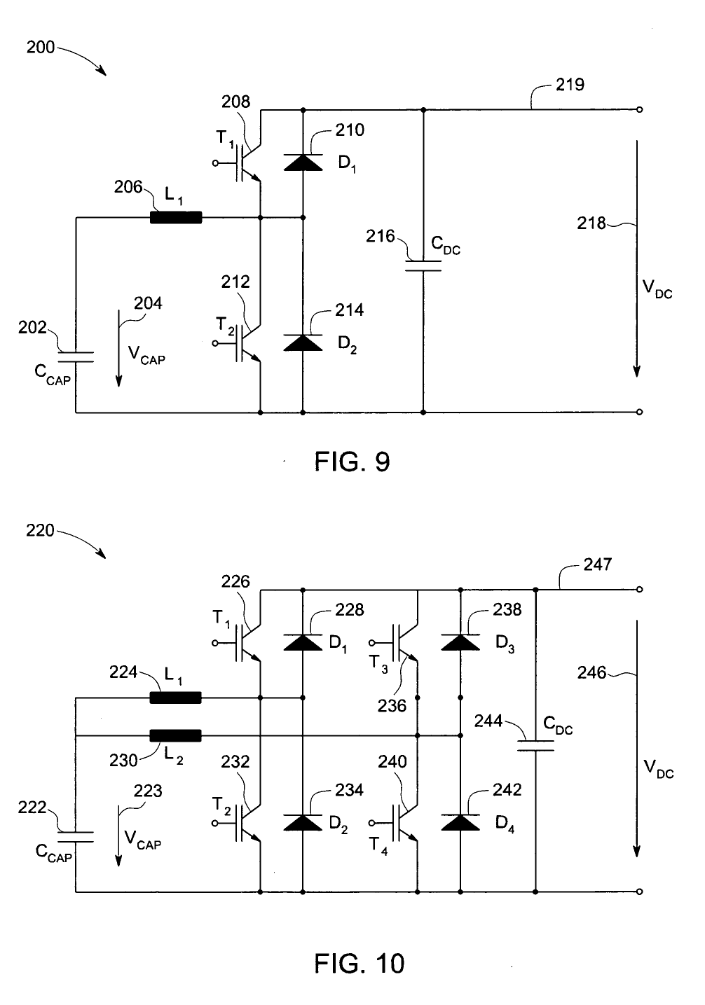

As noted above, when the state of the supercapacitor desalination is transferred from a charging state 58 to a discharging state 60, there is an energy release in the system, similar to the energy release when a system goes from an ordered state to a disordered state. As will be described in detail below, it is desirable to utilize this energy for further use by the system. In the illustrated embodiment, the cell 54 includes an energy recovery converter 66 in the charging and discharging states 58 and 60, respectively. In the charging state 58, the energy recovery converter 66 directs the power supply from a power source, such as a battery (not shown) to the cell 54. Whereas, in the discharging state, the energy recovery converter 66 recovers the energy released by the cell 54 while converting from the charging state 58 to the discharging state 60. Subsequently, this recovered energy is at least partially transferred to the energy storage devices, such as the supercapacitor cell, a battery, or a grid through the converter 66. For example, this recovered energy from the cell 54 may be used at a later stage while charging the cell 54 or a different cell from a stack of cells. In one embodiment, to improve the energy conversion efficiency, a number of cells can be taken in series to form a stack and connected to energy recovery converter 66. The working of the energy recovery converter, such as converter 66 will be described below with regard to FIGS. 9-11. Alternatively, the energy recovered from the stack through the energy recovery converter 66 may also be used by any other stacks in the arrangement, as will be described with regard to FIG. 6. In either of these embodiments, the energy converters, such as the energy recovery converter 66, may be referred to as bi-directional converter as there are two directions of energy flow through the converter. For example, the energy may either flow from the stack to a grid or bus, or from the grid or bus to the stack. In certain embodiments, these converters may recover the energy of the discharging cell in DC form in the discharging state and later, transfer it to the cell in the DC form to charge the cell 54 to convert it from a discharging state 60 to a charging state 58. Similarly, the cell 54 includes a power supply source, such as a battery 66 or a grid in the discharging state 60.

Although for illustrative purposes, in the various embodiments, the electrodes were shown as plates, the electrodes may have various other shapes. For example, the electrodes may form a cylindrical shape as illustrated in FIG. 5. In the illustrated embodiment, the supercapacitor desalination cell 74 includes two electrodes 76 and 78, and two insulating spacers 80 and 82 all of which are co-centrically wound into a hollow cylinder or roll 86 around an inner core, such as a pipe 84. In certain embodiments, the pipe 84 may be used to feed the liquid into the cell 74. In these embodiments, the pipe 84 may include a perforated material. In certain embodiments, the fabrication of such cells 74 may be achieved by using winding machines. In these embodiments, the sheets of electrodes and insulating spacers may be continuously fed into the machine for winding as a roll. The central portion may be formed so as to fit a pipe, such as the pipe 84 of desired diameter. After the roll is cut and secured with a tape, a free-standing supercapacitor desalination cell is formed.

FIG. 6 illustrates a system for de-ionization of liquids having charged species. In the illustrated embodiment, the system 90 employs a plurality of supercapacitor desalination stacks, and a plurality of energy recovery converters. In these embodiments, each of the plurality of stacks 92, 94 and 96 includes a plurality of supercapacitor desalination cells 98, 100 and 102, respectively. Although for illustrative purposes three stacks 92, 94 and 96 are shown in the system 90, as will be appreciated, the system 10 may include less than three stacks or may include more than three stacks. Typically, the number of such stacks employed in the system 90 depends on the feed concentration of the liquid, which is to be desalinated.

In certain embodiments, the cells, such as the cells 98, 100, and 102 in the stacks may be arranged in series. As noted above, a dilute liquid formed by passing the feed liquid through a supercapacitor desalination stack 92, 94 or 96 may again be fed into same or different supercapacitor desalination stack to further lower the concentration of charged ions in the liquid. Accordingly, to obtain product water with low ion concentration from a feed of seawater or brackish water, which have high concentrations of charged ions, a hydraulic flow path may be staged according to different feed concentrations. Each stage may include a group of cell stacks based on the yield of the product water. In certain embodiments, to improve energy conversion efficiency of the de-ionization system, 10 to 800 single supercapacitor desalination cells, each of which has an insulating spacer and a pair of electrodes may be employed in the system 90. In one embodiment, these cells may be arranged in one stack. In another embodiment, these cells may be distributed in different stacks.

In embodiments where the stack includes cells in series, the power efficiency of the energy recovery converter may be higher at high voltage ranges. Typically, voltage in each single supercapacitor desalination cell may be about 1 volt. Therefore, in such stacks where the cells are in series, the maximum voltage may be in a range from about 10 volts to about 800 volts depending upon the number of the cells in series.

Further, the two terminals, an anode and a cathode, of each stack 92, 94 and 96, are electrically coupled to the corresponding bi-directional DC-DC converters 106, 108, and 110, respectively. For example, the stack 92 includes an anode terminal 112 and a cathode terminal 114. Similarly, the stack 94 includes an anode terminal 116 and a cathode terminal 118, and the stack 96 includes an anode terminal 120 and a cathode terminal 122. As with the stacks, the system 90 may include either a lesser or greater number of converters than illustrated. Further, as illustrated by arrows 125, 127 and 129, the energy flow between the stacks and the respective converts may be in either direction. That is, the energy may either flow from the stack to the convert in the discharging state of that particular stack, and the energy may flow from the converter to the stack in the charging state of that particular stack.

In the illustrated embodiment, the other side of the DC-DC converters, such as converters 106, 108 and 110 may be connected to a rectifier 126 through a common DC-bus 128. The voltage of the DC-bus 128 may be controlled by the rectifier 126, which is connected to the grid 130. In certain embodiments, the voltage of the DC-bus 128 may be maintained at a predetermined value to achieve high energy conversion efficiency of the system 90. In these embodiments, the voltage on the stacks 92, 94 or 96 may vary in the charging and discharging states. In the charging state, the energy is fed to stacks 92, 94 and 96 through the bi-directional DC-DC converters 106, 108 or 110 from the grid 130 and the rectifier 126, or from any other stack. For example, in the charging state of a particular stack, such as stack 92, the energy released by another stack, such as stack 94, may be utilized by the converter 106 and fed to the stack 92.

Alternatively, the energy released by a particular stack, such as the stack 94, during discharging, may also be fed back to the grid 130. In the discharging process, energy stored in a stack is released and directed to the DC-bus 128 through the corresponding bi-directional DC-DC converter 108. This recovered energy may be fed back to the grid 130 or alternatively, may be reused to charge the stacks in the desalination process. In certain embodiments, the charging and discharging processes are controlled by bi-directional DC-DC converters with the current-based control strategy.

FIGS. 7 and 8 illustrate exemplary systems 132 and 164 for de-ionization of a feed liquid. In the illustrated embodiments, the systems 132 and 164 include a combination of a supercapacitor desalination device and a reverse osmosis unit.

FIG. 7 illustrates a system 132 in which the feed water is initially processed by a supercapacitor desalination cell and subsequently treated in a reverse osmosis (RO) unit. In the illustrated embodiment, the solid arrows represent the flow of the liquid, whereas the dashed arrows represent the flow of the energy or power in the system 132. In the illustrated embodiment, the feed water 136 may be subjected to a pre-treatment 138 before being fed into a supercapacitor desalination device 140. The pre-treatment may include filtering or bleaching. The pre-treatment 138 may be performed to reduce such impurities from the water, which may be easily removed by other simpler processes. This way the process of de-ionization may be made faster and more efficient. The supercapacitor desalination device 140 may include one or more supercapacitor desalination cells, or stacks, such as stacks 92, 94 or 96 (see FIG. 6). Further, depending upon the number of stacks employed in the device 140, the device 140 may be coupled to one or more energy converters 142, such as a bi-directional DC-DC converter. As indicated by the forward and backward arrows 144, the energy flow from the converter 142 may be both ways, that is, the converter 142 may either receive energy from the device 140 or may feed energy into the device 140. Further, the converter 142 may be coupled to an energy management module 146.

In certain embodiments, the energy management module 146 may be used to store the energy from the converter 142, or re-direct the released energy from one stack of the device 140 to another stack. In one embodiment, the module 146 may include a three-phase rectifier, such as rectifier 126 (see FIG. 6). Further, the direction of energy flow between the converter 142 and the module 146 may be both ways, as indicated by the arrow 148. In other words, the converter 142 may transfer the energy onto the module 146 and may call back energy from the module 146 when required. In the illustrated embodiment, the energy management module 146 may be coupled to an electric grid 150.

Further, the first dilute liquid 152 from the supercapacitor desalination device 140, resulting from the processing of the feed liquid 136 may be fed into a reverse osmosis unit 154. In certain embodiments, a pump 156 may be used to direct and feed the dilute liquid 152 into the reverse osmosis unit 154. In the illustrated embodiment, the energy management module 146 may be coupled to the pump 156 and supply energy to the pump 156 as indicated by the arrow 145. Subsequent to being treated in the reverse osmosis unit 154, the second dilute liquid 158 may be subjected to post treatment 160 to produce the product liquid 162. In an exemplary embodiment, the post treatment 160 may include pH adjustment, mineral level adjustment, hardness adjustment, UV radiation, and filtration through active carbon loading with silver particles.

FIG. 8 illustrates an alternate embodiment of the system 132 of FIG. 7. As with the embodiment illustrated in FIG. 7, in the illustrated embodiment, the solid arrows represent the flow of the liquid, whereas the dashed arrows represent the flow of the energy or power in the system 164. In the illustrated embodiment, the feed liquid 166 is subjected to pre-treatment 168 prior to being fed into the reverse osmosis unit 170 through a pump 172. The resulting first dilute liquid 174 may then be fed into the supercapacitor desalination device 176. As with the supercapacitor desalination device 140 of FIG. 7, the supercapacitor desalination device 176 may be coupled to a bi-direction energy converter 178 as indicated by the arrow 180. As with the converter 142 of FIG. 7, the converter 178 in turn may be coupled to an energy management module 182 as indicated by the arrow 179. Further, the energy management module 182 may also be configured to supply power to the pump 172 as indicated by the arrow 173. Further, the module 182 may be coupled to the grid 184.

Subsequent to being treated in the supercapacitor desalination device 176, the dilute liquid 186 may be subjected to post treatment 188 to produce product liquid 190.

Several topologies may be employed as the bi-directional DC-DC converters in the energy recovery converters. For example, a bi-directional half-bridge DC-DC converter, an interleaved bi-directional half-bridge DC-DC converter, a bi-directional full bridge DC-DC converter, or combinations thereof, may be employed. Typically, these converters work in two modes: the “buck mode” and the “boost mode.” In the buck mode, energy is converted from the DC-bus to the stack, while in the boost mode, the energy is transferred from the stack to the DC-bus. FIGS. 9-11 illustrate alternate topologies of energy recovery converters. As will be appreciated, the energy recovery converters may have several different topologies other than the ones depicted in the exemplary embodiments of FIGS. 9-11. In certain embodiments, the topologies may provide continuous current input and output in the energy recovery system/stack. Additionally, it is desirable for these topologies to possess high power conversion efficiency. As used herein, the term “power conversion efficiency” may refer to the ratio of the output of electrical power transferred by the energy recovery converter to electrical power fed into the converter by supercapacitor desalination device in the discharging state, or the ratio of electrical power fed into supercapacitor desalination device from energy recovery converter to the electrical power input into the converter in the charging state. In some embodiments, the power conversion efficiency of these topologies may be in a range from about 70 percent to about 95 percent, and preferably from about 80 percent to about 90 percent. In these embodiments, the ratio of the maximum voltage to the minimum voltage of the stack in both the charging or discharging states may be upto about 6:1.

FIG. 9 illustrates a topology 200 of a bi-directional half-bridge DC-DC converter. C_{CAP} 202 indicates the capacitance of the supercapacitor desalination device or stack coupled to the converter. The arrow V_{CAP} 204 indicates the voltage of the stack. The topology 200 of a bi-directional half-bridge DC-DC converter includes a single leg with inductor L₁ 206, where the leg includes, Insulated Gate Bipolar Transistors (IGBTs) T₁ 208 and T₂ 212, anti-parallel power diodes D₁ 210 and D₂ 214, and a DC-bus capacitor CDC 216. The arrow V_{DC} 218 indicates the voltage across the DC-bus 219. In the charging state of the stack or the buck mode of the converter, the DC-bus voltage V_{DC} is higher than the voltage of the stack V_{CAP}.

In the buck mode, T₂ 212 is shut down and T₁ 208 is working in PWM (pulse width modulation) mode. When T₁ 208 is conducting, a voltage of (V_{DC}-V_{CAP}) is applied to the inductor L₁ 206, thereby increasing the inductor current. In this process, the energy is temporarily stored in L₁ 206. When T₁ 208 is shutting down, the current flowing through T₁ 208 is transmitted to D₂ 214. Voltage (V_{DC}) is applied to L₁ 206 and the inductor current decreases. Energy is released to the stack. Subsequently, next cycle starts again, where T₂ 212 is shut down and T₁ 208 is working in PWM mode.

On the contrary, in the boost mode, T₁ 208 is always shut down and T₂ 212 is working in PWM mode. When T₂ 212 is conducting, voltage V_{CAP} is applied to L₁ 206 and the inductor current increases and energy is stored in L₁ 206 temporarily. When T₂ 212 is shutting down, current flowing through T₂ 212 is transmitted to D₁ 210. Voltage of (V_{CAP}-V_{DC}) is applied to the L₁ 206 and inductor current decreases. Energy is released to DC-bus 247, and next cycle begins.

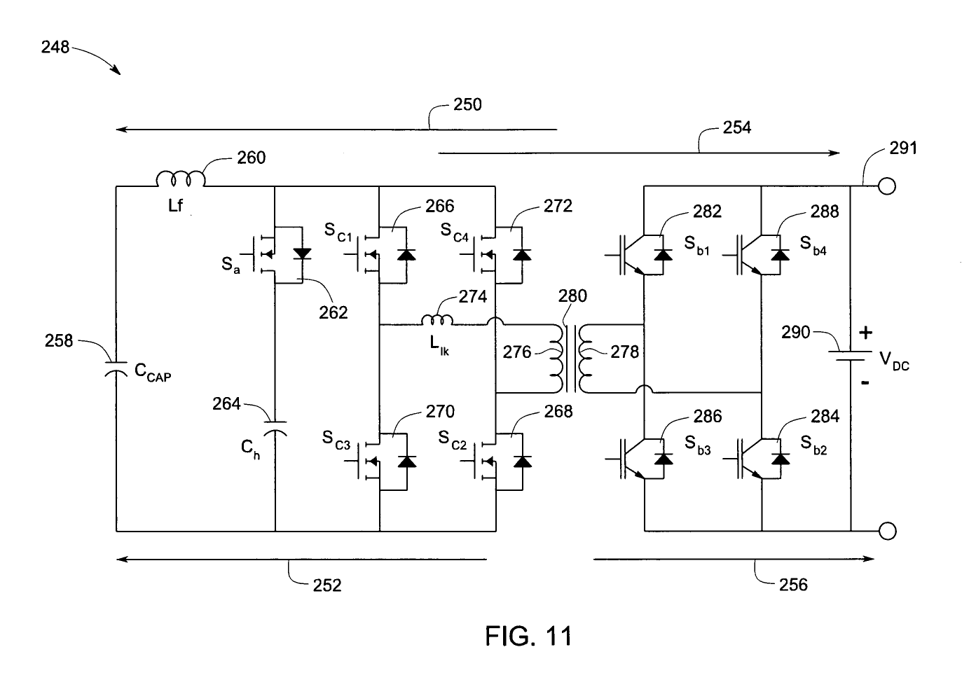

FIG. 10 illustrates a topology 220 of an interleaved bi-directional half-bridge DC-DC converter. In the illustrated embodiment, the topology 220 of the interleaved converter includes two legs with one inductor each, which are interleaved. Further, the topology is coupled to the de-ionization stack C_{CAP} 222. Each leg includes similar elements as noted above with regard to FIG. 9. The first leg includes inductor L₁ 224, Insulated Gate Bipolar Transistors (IGBTs) T₁ 226 and T₂ 232, anti-parallel power diodes D₁ 228 and D₂ 234. The second leg includes inductor L₂ 230, Insulated Gate Bipolar Transistors (IGBTs) T₃ 236 and T₄ 240, and anti-parallel power diodes D₃ 238 and D₄ 242. The topology 220 further includes a DC-bus 247 having a capacitor CDC 244 coupled to the first and second legs. Further, V_{DC} 246 indicates the voltage across the DC-bus.

In the illustrated embodiment, the interleaved converter includes two bi-directional half-bridge DC-DC converters in parallel. Each of the legs operate in a similar manner as described above with regard to FIG. 9. However, in the interleaved converter, the control signal for the T₂/T₄ lags behind the T₁/T₃ with half cycle time, thereby reducing the current ripple in the stack. Also, the combination of two legs may run at relatively lower switching frequency, thereby improving the power conversion efficiency of the converter.

The topologies 200 and 220 illustrated above in FIGS. 9 and 10 respectively are mainly suitable for power applications of less than about 20 kilowatts, and preferably less than about 10 kilowatts. Whereas, the bi-directional full-bridge DC-DC converter illustrated in FIG. 11 may be used for higher power applications relative to the other two converters of FIGS. 9 and 10. In some embodiments, the bi-direction full-bridge DC-DC converter may be used for power applications of more than about 10 kilowatts.

FIG. 11 is the topology 248 of a bi-directional full-bridge DC-DC converter. As will be appreciated, the full-bridge converter 248 includes a low-voltage side as indicated by the arrow 252 and a high voltage side as indicated by the arrow 256. In the presently contemplated embodiment, the low-voltage side 252 is the current-fed type, and the high-voltage side 256 is the voltage-fed type. The arrows 250 and 254 indicate the portions of the topology, which may be in buck and boost modes of operation. As will be appreciated, the mode of operation of the two portions 250 and 254 are different from one other, also the two portions 250 and 254 may alternately be in buck and boost mode of operations.

Further, the topology 248 includes H-bridges in both the stack side and the DC-bus side. The stack side includes inductors L_{f} 260 and Lₗₖ 274, a capacitor Cₕ 264, MOSFETs Sₐ 262, S_{c1} 266, S_{c2} 268, S_{c3} 270, and S_{c4} 272. Further, the topology 248 includes a first coil 276 and a second coil 278 of the transformer 280. On the DC-bus side the topology 248 includes four IGBTs S_{b1} 282, S_{b2} 284, S_{b3} 286, and S_{b4} 288. Further, voltage across the DC-bus 291 is indicated by V_{DC} 290.

In the illustrated embodiment, the diagonally opposite switches, such as S_{c1} 266 and S_{c2} 268, or S_{c3} 270 and S_{c4} 272 in the boost mode, or S_{b1} 282 and S_{b2} 284, or S_{b3} 286 and S_{b4} 288 in the buck mode are turned on and off simultaneously. Further, the signals of S_{c2} 268 and 270 and S_{c4} 272 are delayed with respect to each other, such that the transformer 280 is either connected to the input voltage or shorted. Further, the energy stored in Lₗₖ 274 may be used to discharge the energy stored in Cₕ 264 to achieve zero voltage switching (ZVS) conditions for all switches (IGBTs) on the stack side. Further, the clamp switch Sₐ 262 is turned on under ZVS.

Although only three different topologies are illustrated, as will be appreciated several other topologies of energy recovery converters may be employed in combination with the supercapacitor desalination device of embodiments of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A supercapacitor desalination cell, comprising:
a first electrode comprising a first conducting material, wherein the first electrode is configured to adsorb ions in a charging state of the cell and desorb the ions in a discharging state of the cell, and wherein the first conducting material comprises a conducting composite;
a second electrode comprising a second conducting material, wherein the second electrode is configured to adsorb ions in a charging state of the cell and desorb the ions in a discharging state of the cell, and wherein the second conducting material comprises a conducting composite;
an insulating spacer disposed between the first and second electrodes, wherein the insulating spacer is configured to electrically isolate the first electrode from the second electrode;
a first current collector coupled to the first electrode; and
a second current collector coupled to the second electrode.

2. The supercapacitor desalination cell of claim 1, wherein either or both of the first and second conducting materials comprise a material having a particle size of less than about 100 microns.

3. The supercapacitor desalination cell of claim 1, wherein the conducting composite comprises a conducting polymer, and wherein conducting polymer comprises polypyrrole, polythiophene, polyaniline, or combinations thereof.

4. The supercapacitor desalination cell of claim 1, wherein the conducting composite comprises a sulfonic derivative, a chloride derivative, a fluoride derivative, an alkyl derivative, or a phenyl derivate of polypyrrole, polythiophene, or polyaniline, or combinations thereof.

5. The supercapacitor desalination cell of claim 1, wherein the conducting composite comprises carbides of titanium, zirconium, vanadium, tantalum, tungsten, niobium, or combinations thereof.

6. The supercapacitor desalination cell of claim 1, wherein the first conducting material is different from the second conducting material.

7. The supercapacitor desalination cell of claim 1, wherein the first and second conducting materials are configured to be reversibly doped.

8. The supercapacitor desalination cell of claim 1, wherein the second electrode is disposed parallel to the first electrode.

9. The supercapacitor desalination cell of claim 1, wherein the first and second electrodes are disposed concentrically.

10. The supercapacitor desalination cell of claim 1, wherein the capacitive de-ionization cell has a capacitance in a range from about 100 Farad per gram to about 800 Farad per gram.

11. A supercapacitor desalination device configured to alternate between a charging state and a discharging state, comprising:
a supercapacitor desalination cell configured to adsorb charged species in a charging state, and desorb the charged species in a discharging state, wherein energy is stored by the cell in the charging state, and wherein the stored energy is released by the cell in the discharging state; and
an energy recovery converter operatively associated with the cell and configured to recover the stored energy from the cell in the discharging state of the cell, wherein the converter is configured to transfer at least a portion of the recovered energy to a grid.

12. The supercapacitor desalination device of claim 11, wherein the cell comprises:
a first electrode comprising a first conducting material, wherein the first electrode is configured to adsorb ions in a charging state of the cell and desorb the ions in a discharging state of the cell, and wherein the first conducting material comprises a conducting composite;
a second electrode comprising a second conducting material, wherein the second electrode is configured to adsorb ions in a charging state of the cell and desorb the ions in a discharging state of the cell, and wherein the second conducting material comprises a conducting composite;
an insulating spacer disposed between the first and second electrodes, wherein the insulating spacer is configured to electrically isolate the first electrode from the second electrode;
a first current collector coupled to the first electrode; and
a second current collector coupled to the second electrode.

13. The supercapacitor desalination device of claim 11, wherein the converter comprises a bi-directional half-bridge DC-DC converter.

14. The supercapacitor desalination device of claim 11, wherein the converter comprises an interleaved bi-directional half-bridge DC-DC converter.

15. The supercapacitor desalination device of claim 11, wherein the converter comprises a bi-directional full-bridge DC-DC converter.

16. The supercapacitor desalination device of claim 11, wherein the converter is configured to recover about 70 percent to about 95 percent of a total energy released by the cell during discharging.

17. The supercapacitor desalination device of claim 11, wherein the converter is configured to recover about 80 percent to about 90 percent of a total energy released by the cell during discharging.

18. The supercapacitor desalination device of claim 11, wherein the converter comprises a controller to control a current flow into or out of the cell during the charging state, or the discharging state, or both.

19. The supercapacitor desalination device of claim 11, wherein a footprint of the cell is in a range from about 1 to about 1000.

20. The supercapacitor desalination device of claim 11, further comprising a reverse osmosis unit coupled to the cell, wherein the liquid is fed in the cell to form a first output, and wherein the first output is fed in the reverse osmosis unit to form a final output.

21. The supercapacitor desalination device of claim 11, further comprising a reverse osmosis unit, wherein the liquid is fed in the reverse osmosis unit to form a first output, and wherein the first output is subsequently fed in the cell to form a final output.

22. The supercapacitor desalination device of claim 11, comprising a plurality of cells, and wherein each of the plurality of cells is separated from an adjacent cell by a current collector

23. The supercapacitor desalination cell of claim 22, wherein each of the plurality of cells is connected to an adjacent cell in series.

24. A system configured to de-ionize a liquid having charged species, comprising:
a plurality of stacks, wherein each of the plurality of stacks comprises a plurality of cells, wherein each of the plurality of cells comprises:
a pair of electrodes having a first electrode and a second electrode, wherein the first and second electrodes are configured to adsorb ions in a charging state of the cell and desorb the ions in a discharging state of the cell, and wherein the first and second electrodes comprise a conducting material;
an insulating spacer disposed between the first and second electrodes, wherein the insulating spacer is configured to electrically isolate the first electrode from the second electrode;
a first current collector coupled to the first electrode;
a second current collector coupled to the second electrode; and
a plurality of converters, wherein each of the plurality of converters is coupled to a respective stack, and wherein each of the plurality of converters is configured to store at least a portion of energy released by the respective stack in the discharging state, and wherein each of the plurality of converters is configured to return at least a portion of the stored energy to the respective stack in the charging state.

25. The system of claim 24, wherein each of the pair of electrodes is separated from an adjacent pair of electrode by a current collector.

26. The system of claim 24, wherein each of the electrode pair is connected to an adjacent electrode pair in series.

27. The system of claim 24, wherein each of the plurality of stacks further comprises a pair of support plates, wherein each of the pair of support plates is disposed on either side of the stack.

28. The system of claim 24, further comprising an energy management module in operative association with the plurality of converters, wherein the energy management module is configured to receive electric supply from an external source and pass the electric supply to the system.

29. The system of claim 24, wherein each of the plurality of energy recovery converters are coupled to a common electric bus.
